(19) United States
(12) Patent Application Publication
(10) Pub. No.: US 2018/0372990 A1
(43) Pub. Date: Dec. 27, 2018

(54) OPTICAL MODULAR SYSTEM FOR NEAR-FIELD BEAM DENSITY DISTRIBUTIONS WITH ALTERNATING BEAM DENSITY PROFILE

(71) Applicant: asphericon GmbH, Jena (DE)

(72) Inventors: Ulrike FUCHS, Jena (DE); Sven KIONTKE, Jena (DE); Anna MOEHL, Jena (DE)

(73) Assignee: asphericon GmbH, Jena (DE)

(21) Appl. No.: 16/017,136

(22) Filed: Jun. 25, 2018

(30) Foreign Application Priority Data
Jun. 23, 2017 (DE) 10 2017 113 945.1

(51) Int. Cl. G02B 7/10; G02B 27/30; G02B 27/09

(52) U.S. Cl. CPC G02B 7/10; G02B 27/0955; G02B 27/30

(57) ABSTRACT

A modular system of optical components comprising a phase plate, a focusing lens, and a beam expander. The optical components are each mounted in a housing, which has a first and second fine thread. The first and second fine threads are formed such that they can be screwed together. The mounted phase plate is set up such that, together with an aspherical focusing lens, arranged downstream in the optical path, it forms a focus beam shaper for transforming light, collimated to the optical axis, with a wavelength and an input beam density distribution having a Gaussian profile into an output beam density distribution with an alternating beam density profile in at least one image plane.

This nonprovisional application claims priority under 35 U.S.C. § 119(a) to German Patent Application No. 10 2017 113 945.1, which was filed in Germany on Jun. 23, 2017, and which is herein incorporated by reference.

### BACKGROUND OF THE INVENTION

### Field of the Invention

The present invention relates to an optical modular system for producing focused output beams whose beam density is distributed rotationally symmetrically about the optical axis in a focus area about a focal plane or image plane, wherein due to an image plane perpendicular to the optical axis, the beam density along a beam density profile has one beam density maximum, two beam density maxima, or a central region of constant beam density.

### Description of the Background Art

The beam density profile can be constant in a central region about the optical axis and can drop sharply to zero on both sides of the central region. A beam density profile of this kind will be referred to below as a top-hat profile.

The beam density profile can be bimodal, with a beam density maximum located on both sides of a beam density minimum lying on the optical axis. A beam density profile of this kind will be referred to below as a donut profile.

The beam density profile can also be unimodal, with a single beam density maximum lying on the optical axis. A beam density profile of this kind will be referred to below as a beam-waist profile.

The totality of beam density profiles of this kind will be referred to below as alternating beam density profiles, because such beam density profiles essentially alternate between a top beam density value and a bottom beam density value.

The invention is also directed to focus beam shapers, with which different alternating beam density profiles are produced in different image planes and which are arranged along the optical axis about a focal point and in each case perpendicular to the optical axis.

Focus beam shapers or FBS are known from the prior art with which bundles of collimated input beams, whose distribution in an entrance plane perpendicular to the optical axis is determined by an input beam density distribution with a rotationally symmetric Gaussian profile, are transformed into output beams that are focused in a focal plane, wherein the beam density distribution in the focal plane follows a top-hat profile.

Further, fiber collimators are known for collimating light that exits in a divergent manner from the exit surface of an optical fiber in a solid angle range determined by the numerical aperture of the optical fiber.

Further, beam expanders are known from the prior art with which the diameter of a collimated beam bundle can be changed.

In addition, methods and devices are known with which optical components, for example, beam shapers, fiber collimators, and/or beam expanders, can be connected to one another or fixed relative to each other and can be optically adjusted. For example, optical benches are known which comprise mounting devices for mounting optical components and fixing devices by means of which such mounting devices can be fixed relative to one another. Methods are also known with which optical components can be centered relative to each other with the aid of autocollimators and can be oriented such that the optical axes of the individual components are aligned.

### SUMMARY OF THE INVENTION

It is therefore an object of the present invention to provide an optical modular system comprising a small number of component types, which are provided standardized independent of a specific input beam distribution and a specific output beam distribution. By combining components of the same and/or different component types, optical systems can be formed with which output beams, which produce a beam density distribution with an alternating beam density profile in an image plane located on the exit side, can be generated for a large number of input beam density distributions with a Gaussian profile. Furthermore, the invention is based on the object of providing an optical modular system of this kind, such that optical components of the same and/or different component types can be fixed more easily relative to each other and/or can be optically adjusted.

The modular system comprises, as mounted optical components, at least one mounted phase plate and at least one mounted focusing lens. In one embodiment of the invention, the focusing lens is designed as a focusing aspherical lens. The at least one mounted phase plate is set up such that it can be connected to at least one aspherical focusing lens, arranged downstream in the optical path, so as to form a focus beam shaper.

A focus beam shaper of this kind transforms light, collimated to an optical axis, with a wavelength and an input beam density distribution having a Gaussian profile into an output beam density distribution with an alternating beam density profile in at least one image plane perpendicular to the optical axis. A beam density profile includes the beam density distribution in an image plane along a profile direction perpendicular to the optical axis. An alternating beam density profile along the profile direction has a unimodal or bimodal beam density profile or a beam density profile that is approximately constant in a central region about the optical axis and steeply drops to zero on both sides of this central region.

The modular system further comprises at least one beam expander for the diffraction-limited changing of the diameter of a beam bundle, collimated to the optical axis, of monochromatic light of the same wavelength.

The mounted optical components are each mounted in a tubular housing, arranged coaxially to the optical axis, wherein concentric to the optical axis, an annular first stop and a first fine thread are arranged at a first end of the housing and an annular second stop and a second fine thread at an opposite second end of the housing. The stops and fine threads are suitably formed and arranged such that the second fine thread of a first mounted optical component can be screwed into the first fine thread of a second optical component to a stop position in which the second stop of the housing of the first optical component contacts the first stop of the housing of the second optical component. In this stop position, the screwed-together mounted optical components are oriented such that their optical axes are aligned within the diffraction-limited divergence.

At least one beam expander for an arrangement in the optical path of a focus beam shaper can be set up between a mounted phase plate and a focusing aspherical lens. The beam diameter exiting from the phase plate can be matched to the optically effective diameter of the focusing aspherical lens by means of the beam expander, disposed between the phase plate and the focusing aspherical lens. An advantage of this embodiment is that focus beam shapers can be formed for different diameters of collimated input beam bundles by the addition and arrangement of the beam expander. Thus, it is possible to produce a modular system for producing focus beam shapers, suitable for a particularly large number of applications, with a very small number of differently mounted optical components.

The focusing lens of a focus beam shaper can be mounted and arranged in a housing of the invention such that different lenses with a different focal length and numerical aperture can be easily interchanged and combined with one and the same phase plate. It is possible thereby to produce alternating beam density profiles of different radial extent in focal planes with different distances or focal lengths by simply exchanging the exit-side focusing lens.

Advantageously, the inventive arrangement of optical components in housings allows the production of optical assemblies by simple screwing together. This eliminates further complicated adjustment steps, and a wide variety of optical assemblies with a high-precision, diffraction-limited optical effect can be reliably produced by combining the mounted optical components.

A further advantage of the modular system is that the radial extent of the alternating beam density profile can be easily changed by screwing together a focus beam shaper and at least one beam expander, arranged on the exit side to the focus beam shaper and also mounted in a housing of the invention.

In addition, it is advantageously possible to adapt the diameter of a beam, exiting a mounted phase plate, to the focusing lens, mounted downstream in the optical path, by means of a mounted beam expander. A focus beam shaper of this kind, formed of a mounted phase plate, a mounted beam expander, and a mounted focusing lens, enables the use of focusing lenses with the shortest possible focal length at a given numerical aperture and thus enables an especially short overall length.

In addition, the mounted phase plate, arranged on the entrance side on a focus beam shaper, can be screwed to at least one beam expander arranged on the entrance side. As a result, it is easily possible to adapt the diameter of an input beam to the phase plate arranged on the entrance side.

The modular system additionally can comprise at least one fiber collimator, mounted in a collimator housing, with an entrance for feeding in monochromatic light from an optical fiber and an exit for outputting light collimated along the optical axis. The wavelength ranges designated in each case for the fiber collimator, the focus beam shaper, and the at least one beam expander of the modular system have at least one overlapping region in which a combination of these optical components is functional.

Concentric to the optical axis at the exit of the fiber collimator, an exit-side stop and an exit-side fine thread can be arranged such that the exit-side fine thread of the fiber collimator can be screwed into the first fine thread of a second optical component, mounted in a housing, to a stop position in which the exit-side stop of the fiber collimator contacts and orients the first stop of the second optical component such that the optical axes of the fiber collimator and the second component are aligned within the diffraction-limited divergence.

Advantageously, this embodiment allows the feeding of light from a laser source into an optical assembly, formed by screwed-together optical components, without further adjustment.

The fiber collimator can be made adjustable. The combination of such an adjustable fiber collimator with a mounted focus top-hat beam shaper and optionally with one or more mounted beam shapers is advantageous because the adjustment of an optical assembly formed therefrom is particularly easy.

A first beam expander can have a magnification of 1.5, a second beam expander a magnification of 1.75, and a third beam expander a magnification of 2.0. By screwing together such graduated beam expanders, optical assemblies for beam expansion can be produced over a wide range of overall magnifications and at fine intervals of overall magnifications without additional adjustment.

The modular system can comprise a plurality of sets of optical components, wherein a set of optical components is provided for a wavelength of the fed-in monochromatic light. As a result, the formation of optical assemblies with the retention of the diffraction-limited imaging accuracy is possible with a modular system for multiple wavelengths as well.

The modular system additionally can comprise at least one threaded adapter with a first stop, arranged concentrically and perpendicular to a longitudinal axis, and a first fine thread and a second stop, opposite along the longitudinal axis, and a second fine thread. The fine threads of the threaded adapter are formed and arranged such that they can be screwed into a fine thread of a housing of a mounted optical component to a stop position, in which a stop of the threaded adapter contacts and orients a stop of the mounted optical component such that the longitudinal axis of the threaded adapter is aligned with the optical axis of the mounted optical component within the diffraction-limited divergence of the optical component.

A threaded adapter, its first and second fine threads and its first and second stops can be formed and arranged to match the first fine thread and to match the first stop of a housing of the invention. By means of such an embodiment of a threaded adapter, it is possible to screw the first fine thread of a first housing via the threaded adapter into the first fine thread of a second housing. Thus, it is possible, for example, to screw the first fine thread, usually arranged on the entrance side, of a mounted flared beam expander, opposite the intended beam direction, via a threaded adapter into the first fine thread of a mounted focus beam shaper, such that the beam expander in this screwed-together arrangement has a beam-narrowing effect at the entrance of the focus beam shaper.

Also, the threaded adapter, its first and second fine threads and its first and second stops can be formed and arranged to match the second fine thread and to match the second stop of a housing of the invention. By means of such an embodiment of a threaded adapter, it is possible to screw the second fine thread of a first housing via the threaded adapter into the second fine thread of a second housing. Thus, it is possible, for example, to screw the second fine thread, usually arranged on the exit side, of a mounted flared beam expander, opposite the intended beam direction, via a threaded adapter into the second fine thread of a mounted focus beam shaper, such that the beam expander in this screwed-together arrangement has a beam-narrowing effect at the exit of the focus beam shaper.

In an advantageous manner, the number of different optical systems that can be produced with a modular system can thus be greatly increased via the threaded adapter.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1A schematically shows the optical path through a focus beam shaper;

FIG. 1B schematically shows alternating beam density profiles in different image planes of a focus beam shaper;

FIG. 2 schematically shows a focus beam shaper mounted in a housing;

FIG. 3 schematically shows the optical path in a beam expander;

FIG. 4 schematically shows a beam expander mounted in a housing;

FIG. 5 schematically shows the optical path in beam expanders arranged in a cascade;

FIG. 6 schematically shows a fiber collimator mounted in a housing;

FIG. 7 schematically shows an adjustable fiber collimator; and

FIG. 8 schematically shows a threaded adapter.

### DETAILED DESCRIPTION

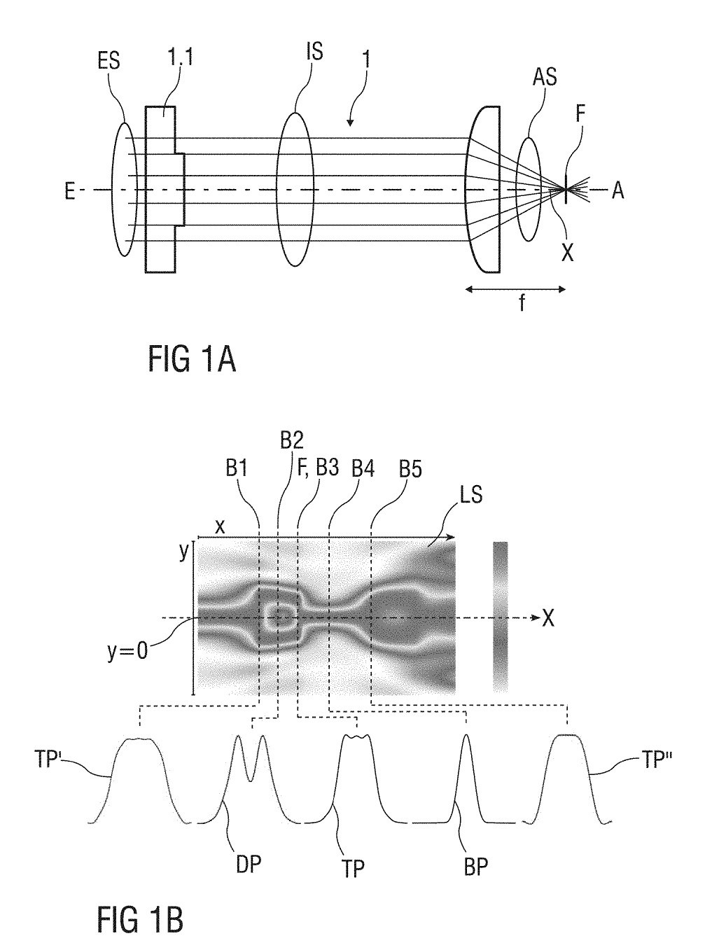

FIG. 1A schematically shows the optical path through a focus beam shaper 1 with an entrance E and an exit A according to the prior art. A phase plate 1.1 is arranged at the entrance side. An aspherical focusing lens 1.2 is arranged at the exit side.

Phase plate 1.1 is formed such that an input light beam ES, collimated to optical axis X, is delayed or phase-shifted in a central region about optical axis X, wherein the achieved phase shift is approximately π. This has the result that the beam density in beam bundle IS, emerging from phase plate 1.1, follows an Airy pattern which is mathematically described by a Bessel function of the first kind and zero order whose dependent variable is the distance from optical axis X. Such phase plates 1.1 and methods for their construction and manufacture are known from the conventional art.

Focusing lens 1.2 is formed such that the beams, collimated to optical axis X, in beam bundle IS are focused diffraction-limited in an exit-side focal point F. Such aspherical focusing lenses 1.2 are known from the conventional art. Also known are methods for constructing such focusing lenses 1.2, with consideration of a predetermined focal length f.

By focusing the collimated beam bundle IS, distributed according to the Airy pattern, as is known, a beam density distribution with a top-hat profile forms in the focal plane comprising focal point F. The extent of the circular inner region of the top-hat profile is determined by the focal length f of focusing lens 1.2. The steepness of the decrease in beam density at the edge of the inner region is limited by diffraction.

In addition to the top-hat profile, further alternating beam density profiles form as a function of the distance x to focal point F in image planes B1 to B5, as is shown schematically in FIG. 1B. The beam density distributed rotationally symmetrically about optical axis X is shown in a longitudinal section LS along optical axis X. A beam density profile along a profile direction y, perpendicular to optical axis X, is thus mirror-symmetric to the zero point y=0 located on the optical axis.

In a first image plane B1, located before focal point F at a distance x=x1<0, the beam density profile has the shape of a first top-hat profile TP′. At a second distance x=x2, x1<x2<0 adjacent in the direction of focal point F, the beam density profile in an image plane B2 has the shape of a bimodal beam density profile or donut profile DP. In an image plane B3, coinciding with the focal plane, at the focal point F at a distance x=0, the beam density profile has the shape of a second top-hat profile TP, which has steeper flanks and a narrower region of high beam density than the first top-hat profile TP′.

The image plane B4, in which the beam density profile has the shape of a unimodal beam density profile or beam-waist profile BP, lies at a distance x=x4>0 after focal point F. At a further distance x=x5>x4, the beam density profile in image plane B5 has the shape of a third top-hat profile TP″ which has less steep flanks compared with the second top-hat profile TP and a narrower region of high beam density compared with the first top-hat profile TP′. It is therefore possible in an advantageous manner by varying the working distance along optical axis X to project different beam density distributions, best suited for the particular application, on an object or workpiece.

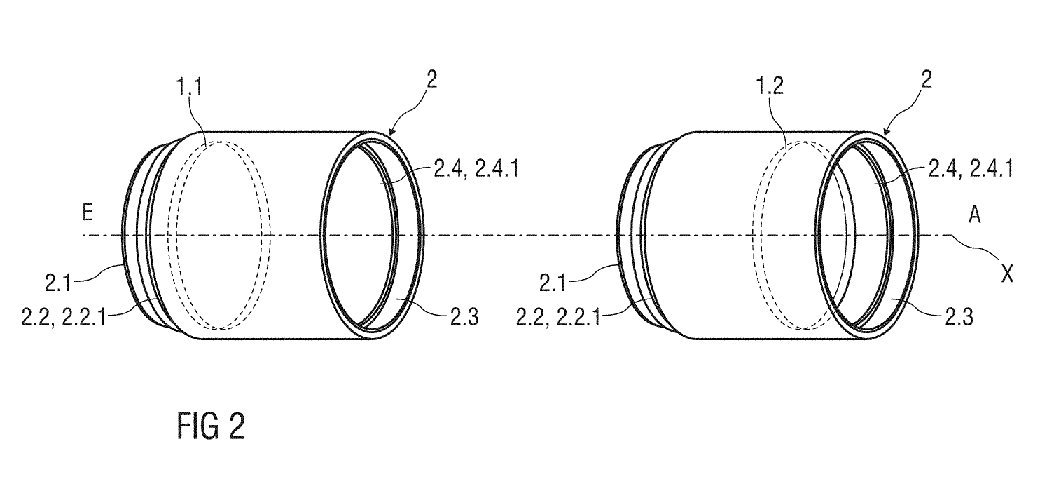

FIG. 2 schematically shows the arrangement of a focus beam shaper 1, with a phase plate 1.1 and a focusing lens 1.2 arranged downstream in the optical path. Phase plate 1.1 and lens 1.2 are each mounted in a tubular housing 2.

Housing 2 has an entrance-side first fine thread 2.1, an annular entrance-side first stop 2.2, an exit-side second fine thread 2.3, and an annular exit-side second stop 2.4. The entrance-side first fine thread 2.1 is formed as an outer thread at whose end facing entrance E, entrance-side first stop 2.2 is arranged. The exit-side second fine thread 2.3 is formed as an inner thread at whose end facing entrance E, the exit-side second stop 2.4 is formed as a radial projection in the inner surface of housing 2.

Fine threads 2.1, 2.3, stops 2.2, 2.4, and housing 2 are arranged coaxially to optical axis X. Stops 2.2, 2.4 each have annular stop surfaces 2.2.1, 2.4.1, which are arranged perpendicular to optical axis X. Fine threads 2.1, 2.3 and stops 2.2, 2.4 are correspondingly formed and arranged such that a first and second housing 2 can be screwed together in that first fine thread 2.1 of first housing 2 can be screwed into second fine thread 2.3 of second housing 2 or second fine thread 2.3 of first housing 2 can be screwed into first fine thread 2.1 of second housing 2.

Advantageously, therefore, focusing lenses 1.2, mounted in housings 2, with a different focal length f and numerical aperture can be combined with the same phase plate 1.1, also mounted in a housing 2, wherein phase plate 1.1 is screwed in on the entrance side relative to lens 1.2. The mounted focusing lenses 1.2 can be formed as mounted focusing aspherical lenses. It is possible by means of mounted focusing lenses 1.2 to produce focus beam shaper 1 with a small number of different components, so as to produce alternating beam density profiles in image planes B1 to B5 about focal planes with a different focal length f and in different radial extents in the respective image planes B1 to B5.

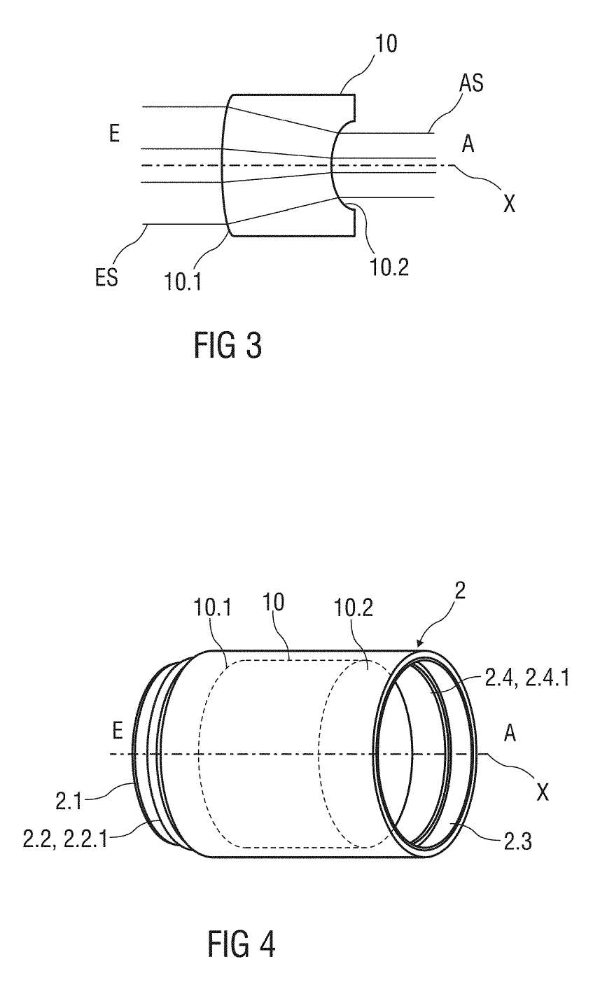

FIG. 3 schematically shows the optical path in a beam expander 10, which is made as a one-piece optical element with an entrance-side first optical surface 10.1 and an exit-side second optical surface 10.2. Beam expander 10 causes an input beam bundle ES to be transformed into an output beam bundle AS. Output beam bundle AS has a diameter that is changed compared with input beam bundle ES but has the same beam density distribution scaled to this changed diameter. Diffraction-limited beam expanders 10, in which optical surfaces 10.1, 10.2 are made as aspherical surfaces, are known from the prior art.

FIG. 4 schematically shows the arrangement of a mounted beam expander in a tubular housing 2 for receiving the one-piece optical element with optical surfaces 10.1, 10.2.

Housing 2 is similar to the housing described in FIG. 2. In particular, it has similarly formed and arranged fine threads 2.1, 2.3 and stops 2.2, 2.4.

Thus, mounted focus beam shapers 1 and mounted beam expanders 10, each arranged in housings 2, can be screwed together, wherein exit-side second fine thread 2.3 of focus beam shaper 1 can be screwed into entrance-side first fine thread 2.1 of beam expander 10 and wherein entrance-side first fine thread 2.1 of focus beam shaper 1 can be screwed into exit-side second fine thread 2.3 of beam expander 10.

In this case, two housings 2 can be screwed in so far until stop surfaces 2.2.1, 2.4.1 of stops 2.2, 2.4 are pressed against each other in a stop position. Fine threads 2.1, 2.3 and stop surfaces 2.2.1, 2.4.1 are made so precisely and optical elements 1.1, 1.2, 10.1, 10.2 are arranged so accurately in housings 2 that the optical axes X of a mounted focus beam shaper 1 and a mounted beam expander, each arranged in a housing 2, align within the tolerance determined by the diffraction limit. In other words: when a focus beam shaper 1, mounted in a housing 2, and a beam expander 10 are screwed in to the stop position, an optical assembly results in which the accuracy of the optical function is limited by diffraction.

The design of housing 2 of the invention makes it possible to screw together a mounted focus beam shaper 1 with one or two mounted beam expanders 10, such that such a focus beam shaper 1 can be flexibly used in various optical assemblies by changing the beam diameter on the entrance side and/or exit side. For example, a too small entrance-side beam diameter can advantageously be widened to the diameter of phase plate 1.1 by screwing in a beam expander 10 on the entrance side upstream of phase plate 1.1. By using a threaded adapter 30, explained in greater detail below, it is also possible to reverse the transmission direction of a beam expander 10 and thus to reduce a too large entrance-side beam diameter by screwing in a beam expander 10 on the entrance side upstream of phase plate 1.1 against the usual transmission direction by means of a threaded adapter 30.

Similarly, a beam diameter can be adapted to the diameter of lens 1.2, arranged downstream in the optical path, by screwing in a beam expander 10, optionally for reversing the beam direction using two threaded adapters 30, between mounted phase plate 1.1 and lens 1.2.

It is an advantage of the invention in this case that no further adjustment of focus beam shaper 1 relative to the at least one beam expander 10 is necessary.

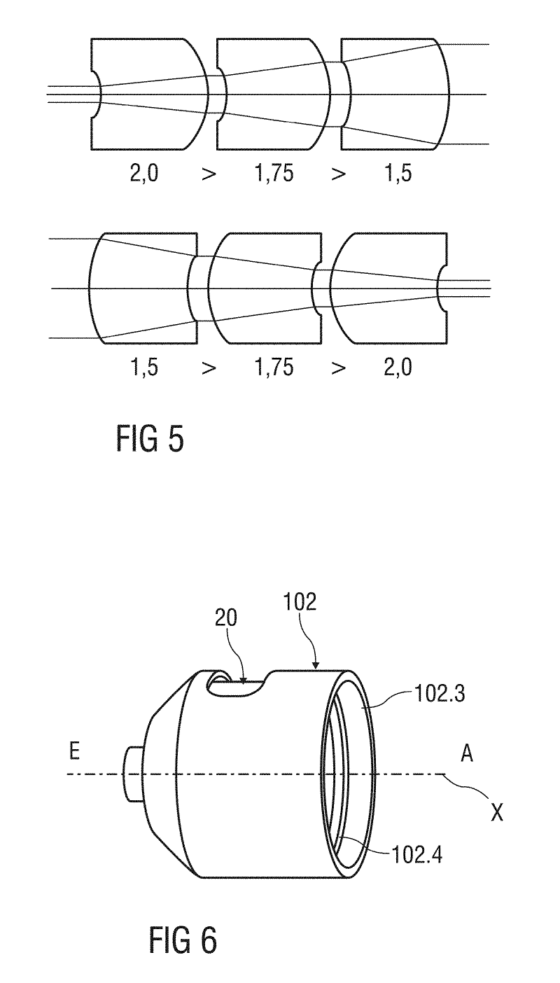

Beam expander 10, as shown in FIG. 5, can also be arranged in a cascade to achieve a greater change in the beam diameter. Advantageously, beam expanders 10 mounted in housings 2 can be screwed in for this purpose without further adjustment. In one embodiment of the invention, fine threads 2.1, 2.3 and stop surfaces 2.2.1, 2.4.1 are made so precisely and optical elements 1.1, 1.2, 10.1, 10.2 are arranged in housings 2 so accurately that optical axes X of a predetermined number of cascaded mounted beam expanders 10 align within the tolerance determined by the diffraction limit. In other words: when a predetermined number of beam expanders 10 mounted in a respective housing 2 are screwed in, an optical assembly is created with a magnification that results as a product of the magnifications of the individual screwed-in beam expanders 10 and at which the accuracy of the optical function is limited by diffraction. In an advantageous manner, it is thus possible, with a limited number of individual mounted beam expanders 10, by screwing in to produce beam expanders as optical assemblies, the magnification of which can be selected over a large range in a very fine graduation.

In one embodiment of the invention, beam expanders 10 have a magnification of 2.0, 1.75, or 1.5, and are screwed in such that beam expander 10 with the greatest magnification is placed at the position with the smallest beam diameter.

FIG. 6 shows, as a further optical component, schematically a fiber collimator 20, mounted in a housing 102, with an entrance-side fiber receptacle 20.4 for receiving an optical fiber. Fiber collimator 20 causes light emerging from the optical fiber to be collimated into an output beam bundle AS collimated to optical axis X. Fiber collimators 20 with optical elements that are formed at least partially aspherical and produce diffraction-limited collimated exit beam bundles AS are known from the prior art.

According to the invention, fiber collimator 20 is provided with a collimator housing 102 which has an exit-side fine thread 102.3 and an exit-side stop 102.4, which are formed and arranged to match an entrance-side first fine thread 2.1 and an entrance-side first stop 2.2 of housing 2 described in FIG. 2. Thus, fiber collimator 20 can also be screwed without adjustment to a mounted focus beam shaper 1. Optionally, one or more mounted beam expanders 10 can be screwed in between mounted fiber collimator 20 and mounted focus beam shaper 1.

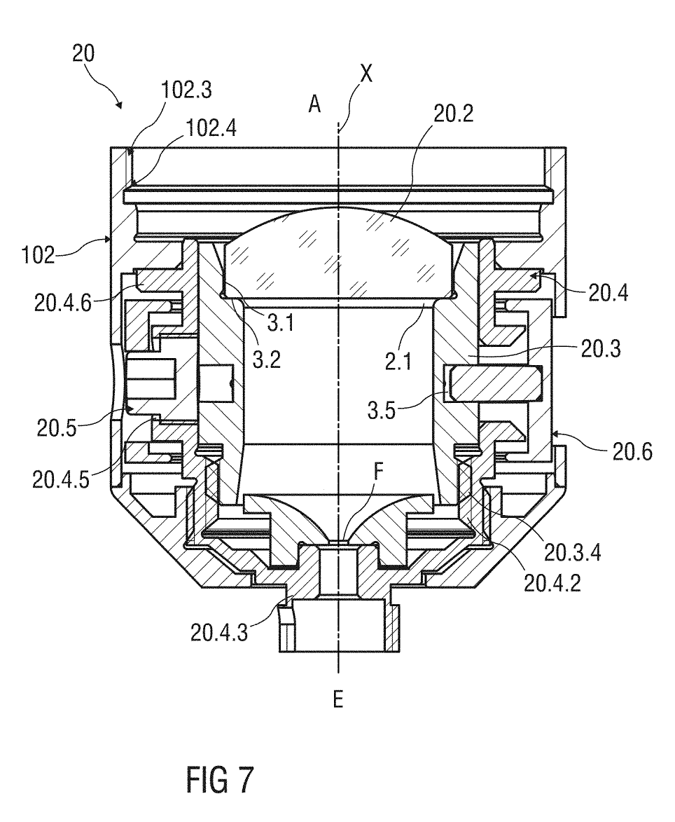

In an exemplary embodiment, fiber collimator 20 is designed as an adjustable fiber collimator, which is described in greater detail in the German patent application DE 10 2017 205 590.1 and is shown in FIG. 7, and which is incorporated herein by reference. The adjustable fiber collimator 20 has an entrance E for feeding in light from an optical fiber and an exit A for outputting light collimated along optical axis X. Such an adjustable fiber collimator comprises a collimator housing 102 in which a Plano-convex lens 20.2 is mounted whose focal point F on the entrance side lies on optical axis X. Collimator housing 102 has an exit-side fine thread 102.3 and an exit-side stop 102.4.

Adjustable fiber collimator 20 further comprises a mount 20.3, with a fine thread 20.3.4, and a tubular fiber receptacle 20.4, concentrically receiving mount 20.3, with a fiber coupling 20.4.3 for receiving the optical fiber, with a radially outwardly projecting retaining stop 20.4.6, with an eccentric receptacle 20.4.5 for rotatably receiving an eccentric fixing screw 20.5 in the sleeve jacket and with a fine thread 20.4.2, which is arranged on the inside of the sleeve jacket, is guided in fine thread 20.3.4 of mount 20.3, and converts a rotational movement about the optical axis into a longitudinal displacement of fiber receptacle 20.4 along the optical axis relative to mount 20.3.

An adjustable fiber collimator 20 further comprises an adjusting shell 20.6 annularly surrounding fiber receptacle 20.4 and rotatable thereto and non-rotatable relative to mount 20.3. Adjusting shell 20.6 comprises a fixation half-shell 20.6.2, which is longitudinally movable against mount 20.3 and which has a fixing slot 20.6.2.2, recessed along the circumference, for receiving screw head 20.5.2 of fixing screw 20.5. Adjusting shell 20.6 is pressed by means of fixing screw 20.5 into a fixing position by static friction against retaining stop 20.4.6 and released by it into a release position.

The combination of such an adjustable fiber collimator with a mounted focus beam shaper 1 and optionally with one or more mounted beam shapers 10 is advantageous because the adjustment of an optical assembly formed therefrom is particularly easy.

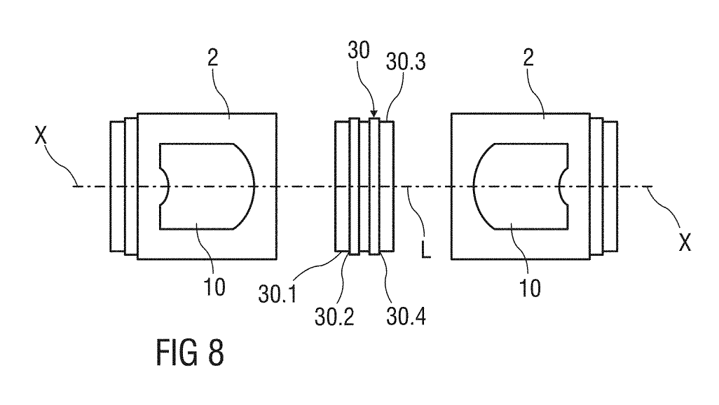

FIG. 8 shows a threaded adapter 30 for the transition from an inner thread to an outer thread. Threaded adapter 30 is formed tubular extending along a longitudinal axis L and has at one end first fine thread 30.1, formed as an outer thread, and a first stop 30.2. At the opposite end, threaded adapter 30 has a second fine thread 30.3, likewise formed as an outer thread, and a second stop 30.4. Fine threads 30.1, 30.3 and stops 30.2, 30.4 are formed and arranged to match second thread 2.3, 102.3, formed as an inner thread, and second stop 2.4, 102.4 of a housing 2, 102, such that in each case a fine thread 30.1, 30.3 of threaded adapter 30 can be screwed into second fine thread 2.3, 102.3 of a first housing 2, 102 and a second housing 2 to a stop position. In this stop position, the longitudinal axis L of threaded adapter 30 is aligned with optical axes X of the optical components which are mounted in first and second housing 2 and which are made by way of example as beam expander 10.

In an analogous manner, fine thread 30.1, 30.3 can be made as an inner thread matching first thread 2.1, formed as an outer thread, and stops 30.2, 30.4 corresponding to the first stop of a housing 2.

Threaded adapter 30 expands the number of optical assemblies that can be produced with the modular system by virtue of the fact that the beam direction of an optical component can be reversed by screwing together threaded adapter 30 and an optical component mounted in a housing 2.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A modular system comprising as optical components:
at least one phase plate;
at least one aspherical focusing lens; and
at least one beam expander for a diffraction-limited changing of a diameter of a beam bundle, collimated to an optical axis of monochromatic light of a same wavelength,
wherein the phase plate, aspherical focusing lens, and beam expander are mounted in a tubular housing and arranged coaxially to the optical axis,
wherein concentric to the optical axis, an annular first stop and a first fine thread are arranged at a first end of the housing, and an annular second stop and a second fine thread are formed and arranged at a second end of the housing such that the second fine thread of a first mounted optical component is adapted to be screwed into the first fine thread of a second optical component to a stop position in which the second stop of the housing of the first optical component contacts and orients the first stop of the housing of the second optical component such that the optical axes of the first and second optical components are aligned within the diffraction-limited divergence, and
wherein the at least one mounted phase plate, together with an aspherical focusing lens, are arranged downstream in the optical path, and form a focus beam shaper for transforming light collimated to the optical axis with a wavelength and an input beam density distribution having a Gaussian profile into an output beam density distribution with an alternating beam density profile at least one image plane.

2. The modular system according to claim 1, wherein at least one beam expander for an arrangement in the optical path of a focus beam shaper is arranged between a mounted phase plate and a focusing aspherical lens.

3. The modular system according to claim 1, wherein focusing lenses, mounted in a housing, of different focal length are combined interchangeably with the phase plate to form a focus beam shaper.

4. The modular system according to claim 1, further comprising at least one fiber collimator mounted in a collimator housing with an entrance for feeding in monochromatic light of the same wavelength from an optical fiber and an exit for outputting light collimated along the optical axis, wherein concentric to the optical axis at the exit of the fiber collimator an exit-side stop and an exit-side fine thread are arranged such that the exit-side fine thread of the fiber collimator is adapted to be screwed into the first fine thread of a second optical component mounted in a housing to a stop position in which the exit-side stop of the fiber collimator contacts and orients the first stop of the second optical component such that the optical axes of the fiber collimator and the second component are aligned within the diffraction-limited divergence.

5. The modular system according to claim 1, wherein a first beam expander has a magnification of 1.5, a second beam expander a magnification of 1.75, and a third beam expander a magnification of 2.0.

6. The modular system according to claim 1, wherein a plurality of sets of optical components are provided, and wherein a set of optical components is provided for a wavelength of the fed-in monochromatic light.

7. The modular system according to claim 1, further comprising at least one threaded adapter with a first stop arranged concentrically and substantially perpendicular to a longitudinal axis, and a first fine thread and a second stop, opposite along the longitudinal axis, and a second fine thread, wherein the fine threads of the threaded adapter are adapted to be screwed into a fine thread of a housing of a mounted optical component to a stop position, in which a stop of the threaded adapter contacts and orients a stop of the mounted optical component such that the longitudinal axis of the threaded adapter is aligned with the optical axis of the mounted optical component within the diffraction-limited divergence of the optical component.

8. The modular system according to claim 7, wherein at least one threaded adapter is provided for the reversal of the beam direction in the at least one beam expander.

9. The modular system according to claim 1, wherein at least one focusing lens is designed as a focusing aspherical lens.
